(19) United States
(12) Patent Application Publication
(10) Pub. No.: US 2011/0189500 A1
(43) Pub. Date: Aug. 4, 2011

(54) Carbon Nanotube Arrays as Thermal Interface Materials

(75) Inventors: Arun Majumdar, Orinda, CA (US); Tao Tong, Oxnard, CA (US); Yang Zhao, El Cerrito, CA (US); Lance Delzeit, Santa Clara, CA (US); Ali Kashani, San Jose, CA (US); Meyya Meyyappan, Pacifica, CA (US)

(73) Assignee: THE REGENTS OF THE UNIVERSITY OF CALIFORNIA, Oakland, CA (US)

(21) Appl. No.: 12/443,864

(22) PCT Filed: Oct. 4, 2007
(86) PCT No.: PCT/US07/80480

§ 371 Date: Apr. 25, 2011

(30) Foreign Application Priority Data
Oct. 4, 2007 (US) PCT/US08/80480

(51) Int. Cl. F28F 7/00; B32B 15/04; B32B 7/00; B32B 9/00; B32B 37/02; B32B 37/14; B82Y 30/00; B82Y 40/00

(52) U.S. Cl. 428/623; 428/457; 428/408; 428/119; 428/433; 428/630; 428/446; 428/336; 156/60; 977/700; 977/902; 977/891

(57) ABSTRACT

Carbon nanotube (CNT) arrays can be used as a thermal interface materials (TIMs). Using a phase sensitive transient thermo-reflectance (PSTTR) technique, the thermal conductance of the two interfaces on either side of the CNT arrays can be measured. The physically bonded interface has a conductance ˜10⁵ W/m²-K and is the dominant resistance. Also by bonding CNTs to target surfaces using indium, it can be demonstrated that the conductance can be increased to ˜10⁶ W/m²-K making it attractive as a thermal interface material (TIM).

### CROSS-REFERENCE TO RELATED APPLICATION

This application claims priority to U.S. Patent Provisional Application No. 60/849,596, filed Oct. 4, 2006, which is incorporated herein by this reference in its entirety.

### STATEMENT OF FEDERAL INTEREST

The invention was funded by a grant from NASA Goddard Space Flight Center, Award Number 016815. The government has certain rights in this invention.

### TECHNICAL FIELD

The present invention relates to novel applications for carbon nanotubes and/or nanofibers.

### SUMMARY

In accordance with one embodiment, a thermal interface material comprises: a base layer; an array of nanostructures on a surface of the base layer; and an indium layer on a surface of the array of nanostructures.

In accordance with another embodiment, a thermal interface material comprises: a base layer; an array of substantially vertically aligned carbon nanostructures on a surface of the base layer; and an indium layer on a surface of the array of vertically aligned carbon nanostructures.

In accordance with a further embodiment, a thermal interface material comprises: a silicon base layer; an array of substantially vertically aligned carbon nanostructures on a surface of the silicon base layer; an indium layer on a surface of the array of vertically aligned carbon nanostructures; and a glass layer on a surface of the indium layer.

In accordance with another embodiment, a method of forming a thermal interface material comprises: forming an array of carbon nanostructures on a first surface; and adhering the carbon nanostructures to a glass plate having an inner layer of indium, such that the carbon nanostructures adhere to the indium layer.

In accordance with a further embodiment, a method of forming a thermal interface material comprises: forming an array of substantially vertically aligned carbon nanostructures on a first surface; and adhering the vertically aligned carbon nanostructures to a glass plate having an inner layer of indium, such that the vertically aligned carbon nanostructures adhere to the indium layer.

### BRIEF DESCRIPTION OF THE DRAWINGS

FIGS. 1A-C are top views of an array of multi-walled carbon nanotube (MWCNT) with increasing magnification showing entanglement of the nanotubes at surface using a scanning electron microscope (SEM), wherein the diameters of the multi-walled carbon nanotubes range from 20 to 30 nanometers (nm).

FIG. 1D is a side view of the MWCNT array where a patch or section of outer surface has been peeled away and/or removed showing the vertical alignment of the tubes.

FIG. 2 is an experimental configuration in accordance with an embodiment.

FIG. 3 is a heat conduction model in accordance with another embodiment.

FIGS. 4A and 4B are graphs showing test measurements using a silicon (Si) wafer of approximately 100 microns (μm) thick, wherein FIG. 4A shows the phase and FIG. 4B shows the amplitude, and wherein the circles are measured data points and solid lines are model calculation with best fit parameters.

FIGS. 5A and 5B are graphs showing experimental measured and model calculated (a) phase and (b) amplitude versus excitation frequency for a 7 microns (μm) long MWCNT array, wherein the circular data points and solid lines represent the measured and calculated values, respectively, for experiment (i); squares and dashed lines refer to experiment (ii); diamonds and dotted curves refer to experiment (iii).

FIGS. 6A and 6B are graphs showing calculated phase curve changes for experiment (ii) data upon ±50% changes in h₁ or h₂ around the best fit values, and absolute values of phase change as a function of frequency with respect to an individual 10% change in each of the experimental parameters around the best fit values, respectively, and wherein H.R. refers to heating spot radius, and P.D. refers to the probe position deviation from the center.

### DETAILED DESCRIPTION

With rapidly increasing power densities in electronic devices, thermal management is becoming a crucial issue in maintaining the reliability and performance. Mainstream personal computer CPUs generate spatially averaged power densities around 60 W/cm², with some local hot spots even more than 500 W/cm². Although large air fans and/or liquid based (including heat pipes) cooling solutions have been applied and can dissipate more than 100 W of total power, thermal resistances at multiple interfaces from the die through the heat spreader to the outside heat sink remain a potential bottleneck. Thermal interface materials (TIMs) need to be applied between contact surfaces to enhance thermal conduction. Two essential attributes of a good thermal interface materials (TIM) are: (i) high mechanical compliance to fill in cavities, and (ii) high thermal conductivity to ensure low thermal resistance. For traditional TIMs, high compliance comes from the fluidity of the base materials, e.g., silicone oil, while high conductivity results from the filling particles, e.g., silver powder. For improved performance, a lot of research has been conducted in search for better filling materials and optimum volume fraction ratio [refs. 1-3]. The best commercially available thermal greases/pastes have thermal conductivities, k, from 1 to 10 W/m·K. Hence, a uniform application of a thin layer a few tens of micrometers thick produces an interface conductance on the order of 10⁵ W/m²·K, causing a ˜10 degree Kelvin temperature jump across each interface. With the trend of increasing power density, traditional TIMs will soon become insufficient in dissipating the ever increasing heat flux. Better TIMs with higher thermal conductance (i.e., approximately 10⁶ W/m²·K) and easy application, e.g., without the need of direct solder bonding, need to be developed.

Carbon nanotubes (CNTs), since their first introduction by Iijima [ref. 4], have been predicted to have very high thermal conductivity at room temperature [ref. 5]. A recent experiment using individual multi-walled carbon nanotube (MWCNT) showed k˜3000 W/m·K at room temperature [ref. 6], while those using individual single-walled carbon nanotube (SWCNT) reported even higher value [ref. 7]. Besides exceptional thermal properties, CNTs are also known to have extraordinary mechanical properties [ref. 5]. They are also compatible with vacuum and cryogenic temperatures, and can sustain elevated temperatures up to 200-300° C. in oxygenic environment, and at least 900° C. in vacuum. CNTs have, therefore, attracted attention as filling-in materials to form composites for improved mechanical and thermal properties [refs. 8-11]. Although previous works demonstrated an enhancement of thermal conductivity by mixing CNTs into composite materials, the effective thermal conductivities only reached a few W/m·K, which are still three orders of magnitude lower than that of CNTs themselves. This indicates that the interfacial thermal resistances of the multiple junctions formed between the randomly dispersed nanotubes and the base materials dominate the thermal conduction.

Recent developments in chemical vapor deposition (CVD) techniques have enabled dense vertically aligned MWCNT arrays to be synthesized on solid substrates, with tube array heights on the order of micrometers and spatial densities ˜10¹⁶-10¹¹ tubes/cm² [refs. 12, 13]. It was conjectured that the vertically aligned MWCNT array directly bridging the two mating surfaces could significantly enhance the overall thermal conductance, because the MWCNTs form highly conductive parallel thermal paths across the mating surfaces with each path containing one nanotube and two contact junctions at the two mating surfaces. Such an arrangement would minimize the many tube-matrix junctions present in the random fill-in scheme. The high spatial density ensures a relatively high fill-factor of about 10%.

Recently, Xu and Fisher [ref. 14] showed their experimental work in measuring contact thermal conductance of MWCNT arrays. In their work, MWCNT arrays were grown on single crystal Si wafers. The Si wafer was then sandwiched between two copper cylinders for thermal measurement. In one-dimensional (1-D) steady state measurement, a constant heat flux was supplied through the copper cylinders across the Si wafer with MWCNT array. The temperature distribution of the copper cylinders was imaged using an infrared camera. The overall interface thermal conductance was determined by extrapolating the temperature jump across the sample. With calibration experiments, they obtained a maximum thermal conductance of about 4.4×10⁴ W/m²·K between the MWCNT array and the copper bar interface under a pressure of 0.44 MPa. Ngo et al. [ref. 11] measured a maximum of 3.3×10⁴ W/m²·K between a copper electro-deposition filled carbon nanofiber array and the copper bar interface under a pressure of 0.4 MPa using a similar measurement scheme. Hu et al. [ref. 15] used a high spatial resolution infrared camera and observed an even lower contact conductance, <10⁴ W/m²·K, at the brush-brush contact interface between two facing CNT arrays.

In Xu et al. and Ngo et al.'s experiments, they neglected the thermal interface resistances between the MWCNT layers and the growth substrates, which are difficult to determine with the steady state measurement methods. Differentiation of component resistances requires additional calibration experiments, and sometimes such control experiments themselves can be rather difficult to perform, e.g., MWCNT-Si substrate interface, because of signal-to-noise and measurement sensitivity issues.

In accordance with one embodiment, a phase sensitive transient thermo-reflectance (PSTTR) technique, originally developed by Ohsone et al. [ref. 16], to first study a relatively simple sample configuration with a dense vertically aligned MWCNT array grown on Si substrate is used to study such a MWCNT-on-Si sample when attached to a piece of glass plate from the free MWCNT surface by van der Waals interactions [ref. 17], or with a thermally welded indium middle layer for improved contact. With the transient technique, we were able to distinguish the interface thermal conductance from various interfaces and the thermal properties of MWCNT layer itself. While the measured thermal conductance for the direct contact MWCNT-glass interface is roughly on the same order as those observed by previous researchers, our technique revealed that the CVD growth interface of MWCNT-Si and the indium assisted MWCNT-glass contact have thermal conductance about an order of a magnitude higher, suggesting a practical solution to the poor tip contact problem that has plagued carbon nanotube TIMs.

### Experimentation

### A. Synthesis of MWCNT Array

In accordance with one embodiment, the MWCNTs are grown on a Si wafer by thermal CVD process with transition-metal iron (Fe) as a catalyst. A 10 nm underlayer of aluminium (Al) and a 10 nm layer of Fe were first deposited onto the Si substrate by ion beam sputtering (VCR Group Inc., IBS/TM200S). For some samples, an optional underlayer of molybdenum was deposited to increase the MWCNT-substrate adhesion. Ethylene was used as the feedstock and the growth temperature was about 750° C. Depending on the growth time, the resulting MWCNT arrays have tower heights ranging from a few to more than 100 μm with a spatial density ˜10¹⁰-10¹¹ tubes/cm². A discussions on nanotube growth can be found in Ref. [12].

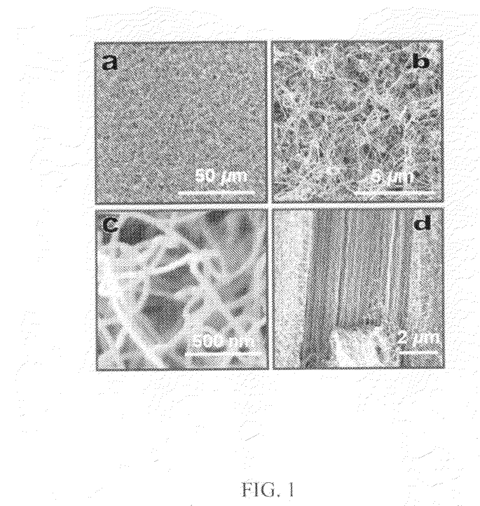

FIG. 1 shows the typical views of the dense vertically aligned MWCNT arrays in accordance with one embodiment, using a scanning electron microscope (SEM). FIGS. 1A-1C show a top view of a MWCNT array with increasing magnification showing entanglement of the nanotubes at surface, and wherein the diameters range from 20 to 30 nm. FIG. 1D shows a side view of the MWCNT array where a patch of outer surface being peeled off, showing vertical alignment of the tubes.

### B. Thermal Measurement Setup

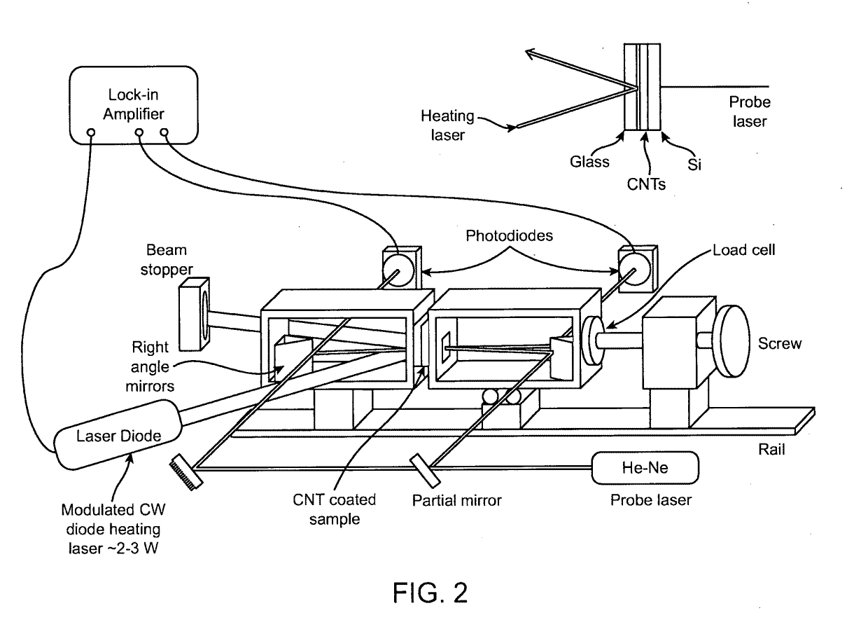

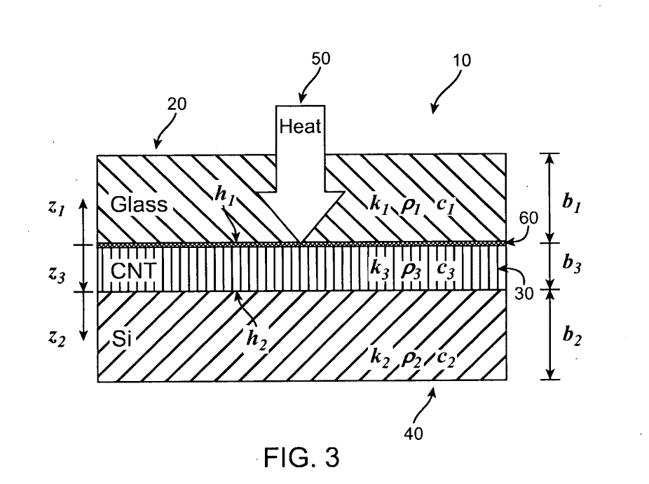

Ohsone et al. [ref. 16] first developed the PSTTR technique to determine the thermal conductance of the interface between thermally grown silicon dioxide (SiO₂) and Si substrate. It can be appreciated that the PSTTR method can be extended to measure the thermal properties of multilayered sample configuration and developed a multi-parameter search algorithm based on a least square fit to the experimental data within the heat conduction model. A detailed discussion of the measurement principle is set forth below. The experimental configuration is shown in FIG. 2. The multilayered sample (upper-right of the FIG. 2 and FIG. 3) consists of MWCNT array grown on a Si substrate, which is directly dry adhered or welded (with 1 μm thick indium layer) to a 1 mm thick glass plate. At the inner side of the glass plate, there is a thin evaporated chromium (Cr, 10 nm)/gold (Au, 100 nm) absorption layer. The sample is mounted on a windowed sample holder made of copper for enhanced waste heat dissipation.

The sample is heated by a diode laser (RPMC, LDX-3315-808 with nominal wavelength of 808 nm and maximum output power ˜3 W) with intensity sinusoidally modulated at angular frequency, ω. The diode laser beam passes through the glass plate and is absorbed at the chromium layer. The heat flux oscillation propagates through the sample causing periodic temperature oscillation. A He—Ne probe laser is focused onto the other side of the sample, located concentrically with the heating laser. The concentric alignment at the backside of the sample is achieved by maximizing the response signal amplitude. The intensity of the reflected beam is modulated by the temperature oscillation at the back surface through the temperature dependence of reflectivity. The reflected probe beam is captured by a photo detector, and the intensity signal is sent to a lock-in amplifier (Stanford Research Systems, SR850) to extract the signal oscillation at frequency, ω. Since the amplitude depends on the values of the reflectivity at the probe wavelength and the thermo-reflectance coefficient of the reflecting material, which are not well documented in literature, predictions based on the magnitude of the amplitude are subject to several unknowns. However, the phase of the temperature oscillation relative to heat flux oscillation is independent of these parameters (apart from signal-to-noise issue), and depends only on the thermal properties of the sample, i.e., conductivity, diffusivity, and interface conductance. Therefore, by measuring the phase of the temperature oscillation at the back surface of the Si substrate, thermal properties of the system can be determined.

### Measurement Principle

### A. Thermal Waves and Phases

The PSTTR method depends on detecting the phase difference between the heat flux input and the temperature response of the sample to determine thermal properties. The simplest case, heat transport in one dimensional (1-D) materials with isotropic and temperature-independent thermal properties, is defined by the governing equation:

$$\frac{1}{α} \frac{\partial T}{\partial t} = \frac{{\partial }^{2} T}{\partial {z}^{2}} \qquad ( 1 )$$

where T is the temperature and α is the thermal diffusivity. Under periodic external excitation with angular time frequency ω, the general solution is easily obtainable:

T(z,t)=Ae^{-z/L}^{ₚ}e^{i(z/L}^{ₚ}^{-ωt)}+Be^{z/L}^{ₚ}e^{i(-z/L}^{ₚ}^{-ωt)} (2)

where Lₚ is the thermal penetration depth (TPD), defined to be Lₚ=\sqrt{2α/ω}. Lₚ denotes the length scale over which the oscillatory thermal energy can propagate before being significantly damped. The two parts of the solution represent thermal waves propagating to the positive and negative x-directions with two complex coefficients, A and B, to be determined by boundary conditions. Let us assume for this 1-D material, a periodic heat flux with amplitude q₀ and frequency ω is injected at the surface (z=0):

q(0,t)=q₀e^{-iωt} (3)

If the material is very thick compared with the thermal penetration depth, one can obtain the temperature solution:

$$T ( z , t ) = \frac{{q}_{0} {L}_{p}}{\sqrt{2} k} {e}^{iπ / 4} {e}^{- z / {L}_{p}} {e}^{i ( z / {L}_{p} - ω t )} \qquad ( 4 )$$

where k is the thermal conductivity. A π/4 phase lag between the temperature response and the heat flux oscillation at the surface is identifiable. In the limit of a thin plate and insulating surfaces where thermal waves get completely reflected at boundaries and bounce back and forth, one can easily find the solution:

$$T ( z , t ) \approx T ( t ) = \frac{{q}_{0}}{ρ cb ω} {e}^{iπ / 2} {e}^{- iω t} \qquad ( 5 )$$

where a π/2 radians phase lag in temperature response is seen and the thin plate is in close analogy to an electrical capacitor. Analogous solutions exist for problems other than 1-D. A simple case which is relevant to our measurement technique is a semi-infinite plate with a periodic point heating source at the surface. The temperature response of the plate as a function of time and distance from the heating spot is [ref. 18]:

$$T ( r , t ) = \frac{{Q}_{0}}{2 π kr} exp [ - r / {L}_{p} + i ( r / {L}_{p} - ω t ) ] \qquad ( 6 )$$

At the heating spot, there is no phase difference between the temperature response and the input heat flux. Phase differences at other positions result only from the traveling wave part. Considering the thin plate limit, summing over the bouncing spherical waves, one can find that the phase difference at the heating spot is still 0. In our laser heating system, depending on the heating spot size, sample sizes, and the heating frequency, phases of the temperature response lie between these limiting values.

### B. Thermal Interface Characterization

The governing equation and the boundary conditions of the axial symmetric three-layer transient heat transfer problem (FIG. 3) can be written as follows:

$$\frac{1}{{α}_{j}} \frac{\partial {T}_{j} ( r , z , t )}{\partial t} = {n}_{j} \frac{1}{r} \frac{\partial }{\partial r} ( r \frac{\partial {T}_{j} ( r , z , t )}{\partial r} ) + \frac{{\partial }^{2} {T}_{j} ( r , z , t )}{\partial {z}_{j}^{2}} , \\ ( j = 1 , 2 , 3 ) \\ f ( r ) {e}^{- i ω t} = {- {k}_{1} \frac{\partial {T}_{1}}{\partial {z}_{1}} \vert}_{{z}_{1} = 0} + {h}_{1} [ {T}_{1} ( 0 ) - {T}_{3} ( 0 ) ] \\ {{k}_{2} \frac{\partial {T}_{2}}{\partial {z}_{2}} \vert}_{{z}_{2} = 0} = {{k}_{3} \frac{\partial {T}_{3}}{\partial {z}_{3}} \vert}_{{z}_{3} = {b}_{3}} = {h}_{2} [ {T}_{2} ( 0 ) - {T}_{3} ( b ) ] \\ {\frac{\partial {T}_{1}}{\partial {z}_{1}} \vert}_{{z}_{1} = {b}_{1}} = 0 ; {\frac{\partial {T}_{2}}{\partial {z}_{2}} \vert}_{{z}_{2} = {b}_{2}} = 0 \qquad ( 7 )$$

where subscript j represents the jth layer (1=glass, 2=silicon, 3=MWCNT); nⱼ is thermal conductivity anisotropy of the jth layer, defined to be the ratio between thermal conductivity in the z-direction (cross plane) and the r-direction (in-plane); h₁ and h₂ are the interface thermal conductances at glass-MWCNT and MWCNT-Si interfaces, respectively; ƒ(r) is the axial symmetric heating function giving the heat flux amplitude distribution and assumed to be a uniform distribution in this work. In accordance with one embodiment, an infinite extension of the sample in the radial plane and insulating boundary conditions at outer surfaces except laser heat injection was assumed. The insulating boundary condition is justified by the small Biot number of the system, <0.01. Nevertheless, the convective heat loss through surfaces has to be considered if one calculates the average temperature rise of the sample (d.c. part of the excitation), which can be estimated ˜10° C. for a 20 mW absorption and 10 W/m²·K convective heat transfer coefficient.

Equations (7) can be solved analytically by integral transform methods [refs. 16, 19]. The governing equation, after Laplace transform in the time domain and Hankel transform in the radial direction, takes the following form:

$$\frac{{\partial }^{2} {w}_{j} ( λ , z , s )}{\partial {z}_{j}^{2}} - ( {n}_{j} {λ}^{2} + \frac{s}{{α}_{j}} ) {w}_{j} ( λ , z , s ) = 0 \qquad ( 8 )$$

where s is the Laplace transform variable related to time frequency, λ is the Hankel transform variable related to spatial wavevector in the radial direction, and w(λ, z, s) is the Laplace and Hankel transformed temperature T(r, z, t). For a set of specified s and λ, the general solution is:

wⱼ=Ãⱼ cos h(ηⱼzⱼ)+\tilde{B}ⱼ sin h(ηⱼzⱼ) (9)

with ηⱼ=(ηⱼλ²+s/αⱼ)^{1/2}. The transformed boundary conditions are:

$$H [ f ( r ) ] \frac{1}{s + i ω} = {- {k}_{1} \frac{\partial {w}_{1}}{\partial {z}_{1}} \vert}_{{z}_{1} = 0} + {h}_{1} [ {w}_{1} ( 0 ) - {w}_{3} ( 0 ) ] \\ {{k}_{2} \frac{\partial {w}_{2}}{\partial {z}_{2}} \vert}_{{z}_{2} = 0} = {{k}_{3} \frac{\partial {w}_{3}}{\partial {z}_{3}} \vert}_{{z}_{3} = {b}_{3}} = {h}_{2} [ {w}_{2} ( 0 ) - {w}_{3} ( b ) ] \\ {\frac{\partial {w}_{1}}{\partial {z}_{1}} \vert}_{{z}_{1} = {b}_{1}} = 0 ; {\frac{\partial {w}_{2}}{\partial {z}_{2}} \vert}_{{z}_{2} = {b}_{2}} = 0 \qquad ( 10 )$$

where T is replaced by w, and H [ƒ/(r)] is the Hankel transform of the heating function. Considering the insulating boundary conditions at the front and back surfaces, the general solution can be further written as:

w₁=A₁ cos h[η₁(b₁−z₁)]

w₂=A₂ cos h[η₂(b₂−z₂)]

w₃=A₃ cos h(η₃z₃)+B₃ sin h(η₃z₃) (11)

The constant complex coefficients, Aⱼ and Bⱼ can be determined by matching the other boundary conditions. Specifically [ref. 20],

$${A}_{2} = \frac{H [ f ( r ) ]}{s + iω} \cdot ξ ( λ , s ) \cdot ζ ( λ , s ) \qquad ( 12 )$$

Using inverse Laplace and Hankel transforms, the temperature distribution in real space can be recovered. The temperature at the backside of Si layer, where the probe laser spot is located, is given by:

T₂(r,b₂,t)=e^{-iω}∫_{λ=0}^{∞}{H[ƒ(r)]·ξ(λ,s)·ζ(λ,s)}_{s=-iω}λJ₀(λr)dλ (13)

where the subscript of the curly braces denotes that the expression is evaluated with s=resulting from the contour integral from the inverse Laplace transform. The inverse Hankel transform can be numerically integrated to find the temperature solution.

### Results and Discussion

### A. Test Measurement of Si

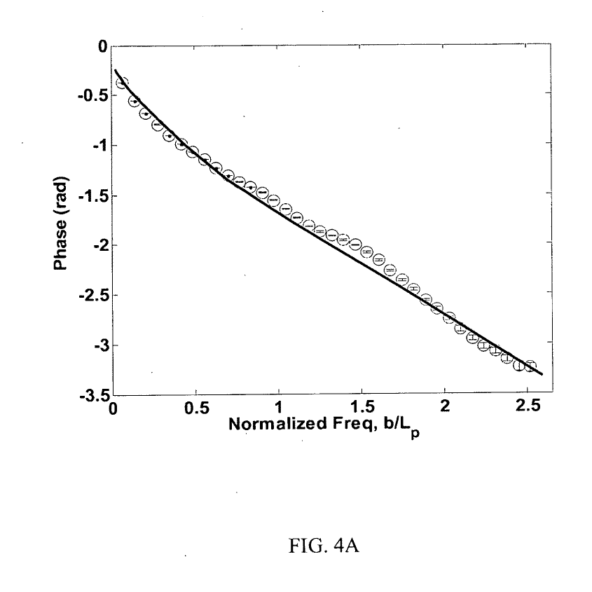

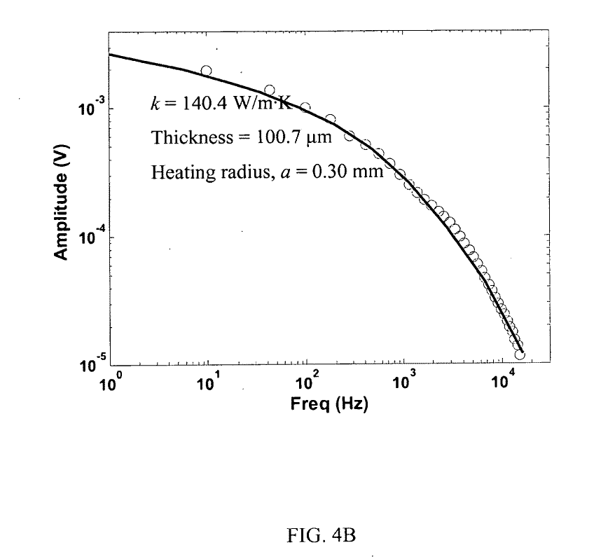

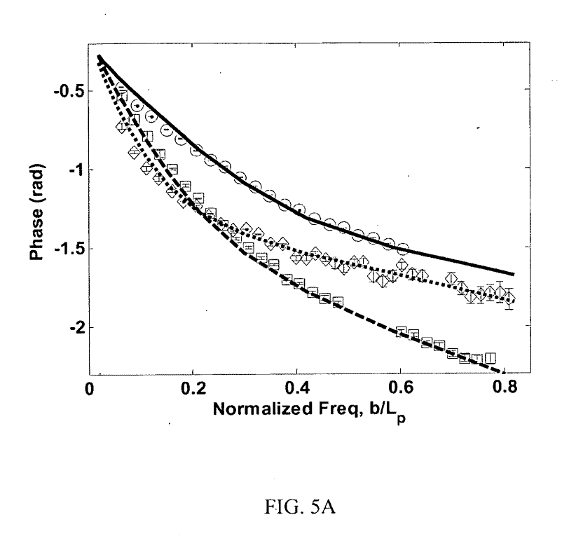

Due to its well documented properties, a Si wafer (nominal thickness 100 μm) was first tested to validate the experimental platform. With front side heating and back side detection, measured data points (circles) and model calculations (solid curves) are shown in FIG. 4. FIG. 4A shows the phase difference between the temperature oscillation at the back surface of Si and the input heat flux (since the phase difference is always negative, it can be appreciated that a phase lag to refer to the absolute value can be used), and FIG. 4B shows the measured amplitude of the temperature oscillation at the back surface and the model prediction (up to an overall normalization constant). It is interesting to note the linear dependence of the phase on the normalized frequency (b/Lₚ=b\sqrt{πθ/α}) in high frequency region (b/Lₚ>_{0.7}). It can be qualitatively understood in the following way. The phase lag at the back side of Si is the sum of the phase lag at the front surface and the traveling wave contribution. At low frequency, when thermal penetration depth is comparable or larger than the plate thickness, the front side phase lag and the traveling wave phase lag both approach 0. Therefore, the total phase lag at the back surface also approaches 0. In high frequency regime, the front surface phase lag approaches π/4, according to the semi-infinite plate prediction defined by Equ. (4). The traveling wave phase lag contribution is b/Lₚ. As a result, the total observed phase lag is b/Lₚ+π/4 at the back surface. Therefore, when plotted with respect to the normalized frequency (b/Lₚ), the phase difference in the high frequency regime gives a straight line with slope −1 and intercept −π/4.

In accordance with one embodiment, the density and specific heat of Si with documented values was fixed, Si thermal conductivity and some experimental parameters that are difficult to measure directly (laser heating spot size, probe spot deviation from the heating center, and the actual thickness of the Si plate) were set to vary within a small range to find the set of values that best fit the measured phase and amplitude (up to an overall normalization constant) using a least square fit approach. The multi-parameter fitting process is based on a sequential search algorithm. The algorithm starts with a set of guessed initial values. During the search process, one fitting parameter is chosen for each search step according to a pre-set sequence. The chosen parameter is allowed to vary around the current value until the overall error between the model and the experimental data is reduced, and then the program proceeds to the next parameter in sequence. The process is repeated until further iterations do not materially alter the results. The best fit thermal conductivity determined by this process is 140.4 W/m·K, which is 5% smaller than the generally documented value of 148 W/m·K [ref. 21].

### B. Measurement of MWCNT Interface Properties

To study the interfacial thermal properties of MWCNT arrays 10, a sample configuration as shown in FIG. 3 was used. The middle layer is a 7 μm high MWCNT array 30 which is grown on the 100 μm thick Si substrate 40 at the bottom. The target layer at the top is a 1 mm thick glass plate 20 coated with chromium adsorption layer 60 (Cr/Au) at an inner surface. The heating laser beam 50 passes through the glass and gets absorbed at the chromium absorption layer 60.

In accordance with one embodiment, a series of three experiments were conducted to study the interface system: (i) no top glass plate, and the heating laser is absorbed directly at the top surface of the MWCNT array; (ii) three-layer configuration with the MWCNT array directly dry adhered to the glass plate by van der Waals interactions between CNT tips and glass surface; (iii) same three-layer configuration except that an additional thin indium layer (1 μm) was deposited on the inner glass surface (Cr/Au coated) and thermally welded the free surface of MWCNTs onto glass. From experiment (i), the thermal properties of the MWCNT array and the MWCNT-Si interface can be studied and used as reference values for later experiments. In experiment (ii), the MWCNT-glass interface thermal conductance is characterized. Expecting the van der Waals interactions based dry adhesion interface to be the major thermal resistance of the system, a further experiment (iii) was performed to see whether an indium welded interface between the glass and the MWCNT would enhance the heat conduction across this interface.

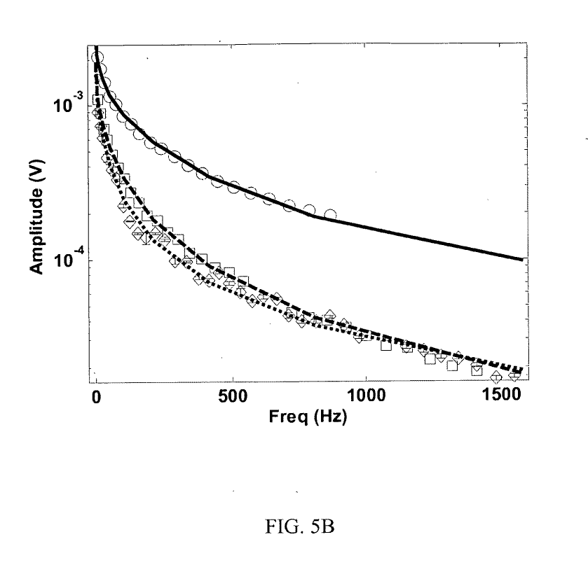

The measured phase and amplitude values of the temperature oscillation at the back surface of the Si layer and corresponding model calculations for the three experiments are shown in FIGS. 5A and 5B. The circular data points and the solid curves in the phase and amplitude figures represent the measured and model calculated values, respectively, for experiment (i). The squares and the dashed curves refer to experiment (ii). The diamonds and the dotted curves refer to experiment (iii). The phase curves for the three experiments show that at the same excitation frequency the phase lags are larger than that in pure Si test, manifesting the effects of the added layers and interfaces. Generally speaking, the larger the phase lag, the larger the thermal resistance the thermal wave feels as it propagates through the material. It is to be noted that the deposited Cr/Au with the optional indium thin layer has an overall thermal conductance>10⁸ W/m²·K [ref. 22] such that their effects in the measurement can be neglected.

Similar numerical processes were used to find the best set of fitting parameters for each experiment and the resulting parameters are listed in Table 1. In accordance with an embodiment, thermal conductance of the CVD growth interface, h₂, between MWCNTs and Si substrate is shown to be on the order of 10⁶ W/m²·K for the three experiments. The range of variation in value is due to experimental uncertainties, which will be discussed in the next sub-section, and spatial variations of the sample itself. For the interface between glass and MWCNTs, h₁, we measured 9×10⁴ W/m²·K for case (ii) with direct contact dry adhesion without external pressure, and 3.4×10⁶ W/m²·K for case (iii) with indium assisted contact. For the MWCNT array, the effective thermal conductivity, k₃, and thermal diffusivity, a₃, were determined to be ˜250 W/m·K and ˜3-8×10⁴ m²/s, respectively. Considering an estimated fill-in ratio of 10% of the MWCNTs, the effective thermal conductivity of the MWCNT array qualitatively matches with the previous measurement of an individual MWCNT [ref. 6].

Results from experiment (ii) shows that the direct contact glass-MWCNT interface has thermal conductance (˜10⁵ W/m²-K) about one order of magnitude lower than that of the CVD growth MWCNT-Si interface. This is about the same range as reported by Xu et al. [ref. 14] and Ngo et al. [ref. 11]. Several options to improve the direct contact interface were considered. Growing MWCNTs from both target surfaces and placing them face-to-face would be tempting, however, the brush-brush contact conductance between two free MWCNT surfaces seems also quite low [ref. 22]. The fact that the CVD growth interface has an order of magnitude higher thermal conductance than the glass interface results from the stronger bonding between the nanotubes and the substrate through the help of underlayer materials. The Al underlayer (˜10 nm) below the catalyst particles melts during the CVD process and forms intimate contact between the Si substrate and the nanotubes. Therefore, if the free end of the MWCNTs and the target surface can be treated similarly, a significant increase in thermal conductance might be expected. Indium was chosen as the contact improvement material because its melting temperature is only 156.6° C. such that welding and separation of the interface can be easily performed by raising the temperature above the melting point. After indium evaporation on the Cr/Au covered glass, the glass plate with the MWCNT sample was placed in an oven and heated up to 180° C. The MWCNT sample was then pressed onto the glass plate, and then the temperature is allowed to cool back down to room temperature. Results from experiment (iii) do show an improved interface thermal conductance at the indium assisted glass-MWCNT interface by an order of magnitude. The overall thermal conductance is also brought up to ˜10⁶ W/m²·K. This is much better than what traditional TIMs can offer. However, it is to be noted that the 1 μm layer of indium seems not thick enough to uniformly bond the whole MWCNT top surface to the glass possibly due to surface variations. As the current optical technique pin-points the local thermal properties within the focal area of the laser spot (diameter ˜0.6-0.9 mm), spatial variations were observed with places of relatively high thermal resistances.

### C. Measurement Sensitivities

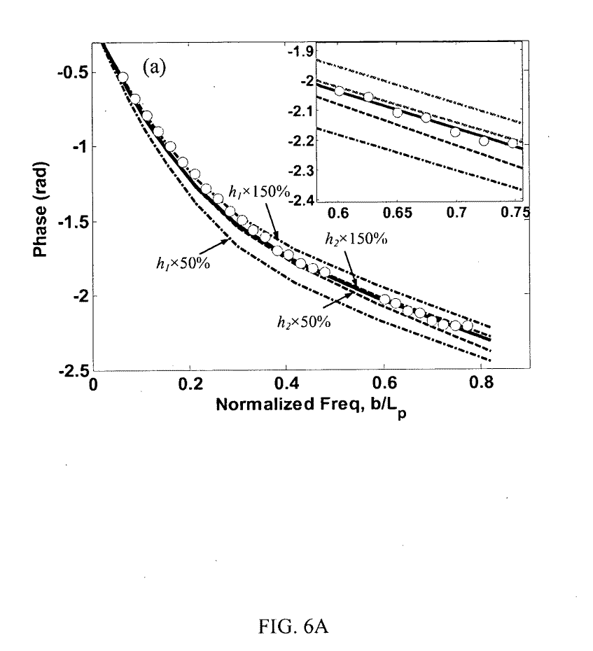

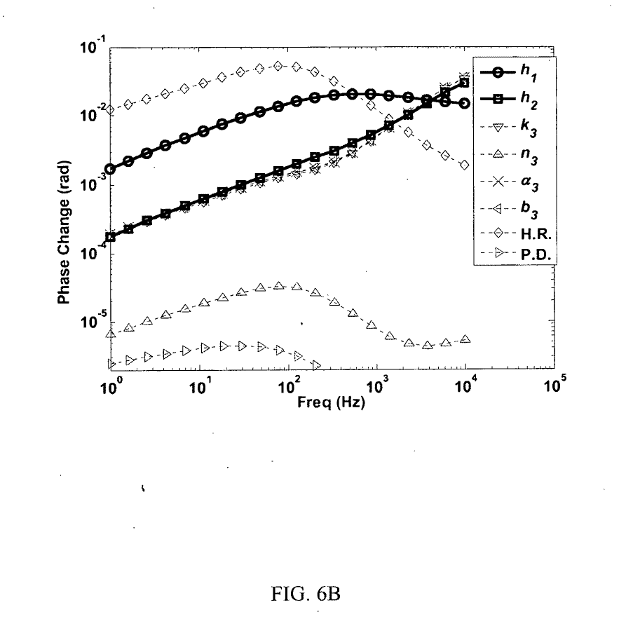

The sensitivity of a measurement system can be generally represented as dφ/dβᵢ, where φ is the output signal, and βᵢ's are the experimental parameters. For our measurement system, when the thermal conductance is high, the differential change in the output signal due to a change in the thermal conductance becomes vanishingly small, making it difficult to accurately determine the thermal conductance based on the output signal. FIG. 6A shows how much the calculated phase curve from experiment (ii) changes upon ±50% changes in h₁ or h₂ around the best fit values. While the changes due to h₁ are quite large around the best fit value of 9.0×10⁴ W/m²·K, the changes due to h₂ around 9.0×10⁵ W/m²·K are smaller. FIG. 6B further shows how much the phase changes in absolute values, |Δφ|, from the reference values (best fit) upon a 10% change of each individual parameter as a function of frequency, namely:

$$\vert Δφ ( ω ) \vert = \vert ( \frac{d φ}{d {β}_{i}} ) ( ω ) \cdot Δ {β}_{i} \vert \qquad ( 14 )$$

where Δβᵢ is 10% of the reference value of each of the experimental parameters. Hence, the greater the change in phase, the higher the sensitivity to that parameter. Similar to FIG. 6A, while sensitive to h₁(circle), the phase is not so sensitive to h₂ (square), especially at lower frequencies. Higher excitation frequency helps increase sensitivity, but usually at the sacrifice of signal-to-noise ratio, as can be seen qualitatively in equation (4): other parameters being fixed, the temperature amplitude goes down with ω^{-1/2} since Lₚ=\sqrt{2α/ω}. Sensitivity and signal-to-noise ratio together determine the measurement limit of the system. In accordance with an embodiment, the current PSTTR system measures thermal conductances up to 10⁶-10⁷ W/m²·K. The well-known 3-omega electrical heating method measures up to ˜10⁸ W/m²·K. Even higher interface conductances require ultrashort laser pulses to resolve.

Another concern in our multi-parameter fitting process is that how to make sure the set of the best fit parameters is indeed the global solution that minimizes the least square error. To avoid the fitting values fall into local minima, large ranges of initial guess values were chosen to test the convergence of the fitting process. Cross comparisons among various different experimental configurations as discussed above also served as a consistency check of the fitted parameters.

In accordance with another embodiment, a phase sensitive transient thermo-reflectance (PSTTR) method was applied to study the thermal properties of dense vertically aligned multiwalled carbon nanotube arrays as a thermal interface material. Through a multi-parameter fitting process, interface thermal conductances and thermal properties of MWCNT arrays were obtained using a least square fit between the experimental data and model calculations. From the measurements of a three-layer test configuration, which consists of a MWCNT array grown on Si substrate directly dry adhered to a glass plate, we identified the most resistant interface between the direct contact glass and MWCNT layer with a thermal conductance ˜9.0×10⁴ W/m²·K, which is at least one order of magnitude lower than that of the CVD growth MWCNT-Si interface, due to poor contact between nanotube tips and the target surface at the direct contact interface. By bonding the nanotubes and glass using an indium weld, an order of magnitude enhancement in the overall thermal conductance was observed, thereby opening up potential uses of dense vertically aligned carbon nanotubes as thermal interface materials in application areas such as electronic packaging, thermal switching in thermal management of cryogenic pumps and spacecrafts, etc.

Nomenclature

A, B Complex coefficients

H[ ] Hankel transform

J₀( ) 0^{th} order Bessel function of the first kind

Lₚ Thermal penetration depth, m

Q Heat flow, W

T Temperature distribution function, K

b Layer thickness, m

c Specific heat, J/kg·K

ƒ Time frequency, sec⁻¹

ƒ(r) Heat flux amplitude spatial distribution function

h Thermal conductance, W/m²·K

k Thermal conductivity, W/m·K

n Thermal conductivity anisotropicity ratio

q Heat flux, W/m²

r Radial coordinate, m

s Laplace transform variable

t Time, sec

w Laplace and Hankel transformed temperature function, K

x Spatial coordinate in 1-D, m

z Cross plane coordinate, m

### Greek Symbols

α Thermal diffusivity, m²/s

βᵢ General parameters

φ System output

λ A Hankel transform variable in radial direction, m⁻¹

ρ Density, kg/m³

ωAngular frequency, rad/s⁻¹

Subscripts

0 Constant

1 Glass layer or glass-MWCNT interface

2 Si layer or MWCNT-Si interface

3 MWCNT layer

j jth material layer

The following references are incorporated herein by reference in their entirety.

### REFERENCES

[1] R. S. Prasher and J. C. Matayabas, Thermal Contact Resistance of Cured Gel Polymeric Thermal Interface Material, IEEE Transactions on Components and Packaging Technologies, vol. 27, pp. 702-709, December, 2004.
[2] V. Singhal, T. Siegmund, and S. V. Garimella, Optimization of Thermal Interface Materials for Electronics Cooling Applications, IEEE Transactions on Components and Packaging Technologies, vol. 27, pp. 244-252, June, 2004.
[3] R. S. Prasher, P. Koning, J. Shipley, and A. Devpura, Dependence of Thermal Conductivity and Mechanical Rigidity of Particle-Laden Polymeric Thermal Interface Material on Particle Volume Fraction, Journal of Electronic Packaging, vol. 125, pp. 386-391, September, 2003.
[4] S. Iijima, Helical Microtubules of Graphitic Carbon, Nature, vol. 354, pp. 56-58, Nov. 7, 1991.
[5] M. S. Dresselhaus, G. Dresselhaus, and A. Jorio, Unusual Properties and Structure of Carbon Nanotubes, Annual Review of Materials Research, vol. 34, pp. 247-278, 2004.
[6] P. Kim, L. Shi, A. Majumdar, and P. L. Mceuen, Thermal Transport Measurements of Individual Multiwalled Nanotubes, Physical Review Letters, vol. 8721, Nov. 19, 2001.
[7] C. H. Yu, L. Shi, Z. Yao, D. Y. Li, and A. Majumdar, Thermal Conductance and Thermopower of an Individual Single-Wall Carbon Nanotube, Nano Letters, vol. 5, pp. 1842-1846, September, 2005.
[8] S. U.S. Choi, Z. G. Zhang, W. Yu, F. E. Lockwood, and E. A. Grulke, Anomalous Thermal Conductivity Enhancement in Nanotube Suspensions, Applied Physics Letters, vol. 79, pp. 2252-2254, Oct. 1, 2001.
[9] M. J. Biercuk, M. C. Llaguno, M. Radosavljevic, J. K. Hyun, A. T. Johnson, and J. E. Fischer, Carbon Nanotube Composites for Thermal Management, Applied Physics Letters, vol. 80, pp. 2767-2769, Apr. 15, 2002.
[10] X. Hu, L. Jiang, and K. E. Goodson, Thermal Conductance Enhancement of Particle Filled Thermal Interface Materials Using Carbon Nanotube Inclusions, Thermomechanical Phenomena in Electronic Systems Proceedings of the Intersociety Conference ITherm 2004, 1, p. 63-69, 2004.
[11] Q. Ngo, B. A. Cruden, A. M. Cassell, G. Sims, M. Meyyappan, J. Li, and C. Y. Yang, Thermal Interface Properties of Cu-Filled Vertically Aligned Carbon Nanofiber Arrays, Nano Letters, vol. 4, pp. 2403-2407, December, 2004.
[12] L. Delzeit, C. V. Nguyen, B. Chen, R. Stevens, A. Cassell, J. Han, and M. Meyyappan, Multiwalled Carbon Nanotubes by Chemical Vapor Deposition Using Multilayered Metal Catalysts, Journal of Physical Chemistry B, vol. 106, pp. 5629-5635, Jun. 6, 2002.
[13] H. J. Dai, Carbon Nanotubes: Synthesis, Integration, and Properties, Accounts of Chemical Research, vol. 35, pp. 1035-1044, December, 2002.
[14] J. Xu and T. S. Fisher, Enhanced Thermal Contact Conductance Using Carbon Nanotube Arrays, Thermomechanical Phenomena in Electronic Systems Proceedings of the Intersociety Conference ITherm 2004, 1, p. 549-555, 2004.
[15] X. J. Hu, M. Panzer, and K. E. Goodson, Thermal Characterization of Two Opposing Carbon Nanotube Arrays Using Diffraction-Limited Infrared Microscopy, Proceedings of ASME International Mechanical Engineering Congress and Exposition, IMECE2005-83005, Nov. 5-11, 2005, Orlando, Fla., 2005.
[16] Y. Ohsone, G. Wu, J. Dryden, F. Zok, and A. Majumdar, Optical Measurement of Thermal Contact Conductance Between Wafer-Like Thin Solid Samples, Journal of Heat Transfer-Transactions of the ASME, vol. 121, pp. 954-963, November, 1999.
[17] Y. Zhao, T. Tong, L. Delzeit, A. Kashani, M. Meyyappan, and A. Majumdar, Interfacial Energy and Strength of Multiwalled Carbon Nanotube Based Dry Adhesive, Journal of Vacuum Science and Technology-B., vol. 24, pp. 331-335, January, 2006.
[18] H. S. Carslaw and J. C. Jaeger, Conduction of Heat in Solids, 2nd ed., Oxford University Press, New York, 1959.
[19] Debnath. L., Integral Transforms and Their Applications, CRC Press, Inc., Boca Raton, 1995.
[20] ξ(λ, s)={h₁k₁η₁h₂k₂η₂S₁S₂S₃+k₃η₃C₃[h₁k₁η₁h₂S₁C₂+k₂η₂S₂(h₁h₂C₁+(h₁h₂)k₁η₁S₁)]+k₃²η₃²S₃(h₁C₁+k₁η₁S₁)(h₂C₂+k₂η₂S₂)}⁻¹;
   ζ(λ, s)=h₂k₃η₃(C₃−S₃)(C₃+S₃)(h₁C₁+k₁η₁S₁);
   where Sⱼ=sin h(ηⱼbⱼ) and Cⱼ=cos h(ηⱼbⱼ).
[21] A. F. Mills, Basic Heat and Mass Transfer, Prentice-Hall, Inc., 1999.
[22] D. G. Cahill, W. K. Ford, K. E. Goodson, G. D. Mahan, A. Majumdar, H. J. Maris, R. Merlin, and S. R. Phillpot, Nanoscale thermal transport, Applied Physics Reviews, J. Appl. Phys., vol. 93, pp. 793-818, 2003.
[23] X. J. Hu, A. A. Padilla, J. Xu, T. S. Fisher, and K. E. Goodson, 3-Omega Measurements of Vertically Oriented Carbon Nanotubes on Silicon, Private communication with the authors.

As described above, in accordance with an embodiment, model parameters that fit the interface experiments with the 7 μm long MWCNT sample are shown in Table 1. The first column under Values refers to experiment (i); the second column refers to experiment (ii); and the third one refers to experiment (iii). Fixed parameters in calculation are glass thickness b₁=1 mm, glass thermal conductivity k₁=1.06 W/m·K, glass thermal diffusivity a₁=6.4×10⁻⁷ m²/s; Si thickness b₂=100 μm, Si thermal conductivity k₂=140 W/m·K, and Si thermal diffusivity a₂=7.4×10⁻⁵ m²/s.

TABLE 1

| | Values | | |
|---|---|---|---|
| | | (ii) Glass- | (iii) Glass-In- |
| Model Parameters | (i) CNT-Si | CNT-Si | CNT-Si |
| Glass-CNT inter. cond., h₁ | — | 9.0 × 10⁴ | 3.4 × 10⁶ |
| (W/m² · K) | | | |
| CNT-Si inter. Cond., h₂ | 2.9 × 10⁶ | 9.0 × 10⁵ | 2.2 × 10⁶ |
| (W/m² · K) | | | |
| CNT cross-plane conductivity, | 244 | 265 | 267 |
| k₃ (W/m · K) | | | |
| CNT anisotropic ratio, n₃ | 9.0 × 10⁻³ | 1.0 × 10⁻² | 1.0 × 10⁻² |
| CNT axial diffusivity, α₃ | 8.4 × 10⁻⁴ | 3 × 10⁻⁴ | 6.9 × 10⁻⁴ |
| (m²/s) | | | |
| CNT thickness, b₃ (μm) | 4.6 | 7.0 | 10.1 |
| Laser heating spot radius, | 0.48 | 0.30 | 0.46 |
| (mm) | | | |

While various embodiments have been described, it is to be understood that variations and modifications may be resorted to as will be apparent to those skilled in the art. Such variations and modifications are to be considered within the purview and scope of the claims appended hereto.

1. A thermal interface material comprising:
a base layer;
an array of nanostructures on a surface of the base layer; and
an indium layer on a surface of the array of nanostructures.

2. The material of claim 1, wherein the array of nanostructures are carbon nanostructures.

3. The material of claim 1, wherein the array of nanostructures are highly conductive nanostructures.

4. The material of claim 1, wherein the array of nanostructures are substantially vertically aligned.

5. The material of claim 1, further comprising a glass layer on a surface of the indium layer.

6. The material of claim 5, further comprising an adsorption layer on an inner surface of the glass layer, the adsorption layer comprised of a layer of chromium and a layer of gold.

7. The material of claim 1, wherein the base layer is silicon.

8-13. (canceled)

14. The material of claim 2, wherein the carbon nanostructures are formed onto the base layer by chemical vapor deposition.

15. The material of claim 2, wherein the carbon nanostructures are attached to the base layer by an underlayer therebetween, and wherein the underlayer comprises aluminum, iron, or molybdenum.

16. (canceled)

17. (canceled)

18. The material of claim 1, wherein the indium layer has a thickness of about 1 μm.

19. (canceled)

20. (canceled)

21. A thermal interface material comprising:
a silicon base layer;
an array of substantially vertically aligned carbon nanostructures on a surface of the silicon base layer; and
an indium layer on a surface of the array of vertically aligned carbon nanostructures.

22. The material of claim 21, further comprising a glass layer on a surface of the indium layer.

23. The material of claim 22, further comprising an adsorption layer on an inner surface of the glass layer, the adsorption layer comprised of a layer of chromium and a layer of gold.

24-29. (canceled)

30. The material of claim 21, wherein the carbon nanostructures are attached to the base layer by an underlayer therebetween, and wherein the underlayer comprises aluminum, aluminium and iron, or molybdenum.

31. (canceled)

32. (canceled)

33. The material of claim 21, wherein the indium layer has a thickness of about 1 μm.

34. A method of forming a thermal interface material comprising:
forming an array of carbon nanostructures on a first surface; and
adhering the carbon nanostructures to a glass plate having an inner layer of indium, such that the carbon nanostructures adhere to the indium layer.

35-40. (canceled)

41. The method of claim 34, wherein the carbon nanostructures are formed by chemical vapor deposition.

42. The method of claim 34, wherein the carbon nanostructures are attached to the first surface by an underlayer therebetween, and wherein the underlayer comprises aluminum, iron or molybdenum.

43-45. (canceled)

46. The method of claim 34, wherein the first surface is a silicon wafer.

47. The method of claim 34, wherein the glass layer further includes an adsorption layer on an inner surface of the glass layer, the adsorption layer comprised of a layer of chromium and a layer of gold.
